(19) United States
(12) Patent Application Publication
(10) Pub. No.: US 2013/0205670 A1
(43) Pub. Date: Aug. 15, 2013

(54) APPARATUS FOR OPENING AND CLOSING A BARRIER

(71) Applicant: Ultra Aluminum Manufacturing, Inc., (US)

(72) Inventors: Russell Harry Springborn, Union City, MI (US); David Gerard Kolton, Howell, MI (US)

(73) Assignee: Ultra Aluminum Manufacturing, Inc., Howell, MI (US)

(21) Appl. No.: 13/748,366

(22) Filed: Jan. 23, 2013

Related U.S. Application Data
(60) Provisional application No. 61/589,660, filed on Jan. 23, 2012.

(51) Int. Cl. E05F 15/12

(52) U.S. Cl. CPC E05F 15/12
USPC 49/358

(57) ABSTRACT

An apparatus for opening and closing a barrier includes a rotatable housing having a first stop surface extending outwardly from an outer surface of the housing, said housing being configured for attachment of said barrier; an electric motor disposed within the housing, said motor having a rotor coupled to a first shaft having an axis, said motor further including a stator fixedly coupled to said housing; a member configured to receive and mechanically fix an end of a second shaft thereto; and a mounting bracket configured for connection to a fixed post, said mounting bracket connected to the member and having a second adjustable stop surface configured to contact the first stop surface and limit rotational movement of said housing relative to said mounting bracket in a first rotational direction, wherein the motor is configured to be selectively activated to effect relative rotational movement of the rotor relative to the stator, and the rotational movement of the motor relative to the mounting bracket causes rotational movement of the housing relative to the mounting bracket. Other apparatuses for opening and closing a barrier are also described.

### CROSS-REFERENCE TO RELATED APPLICATIONS

This application claims the benefit of U.S. Provisional Application No. 61/589,660 filed Jan. 23, 2012 (the '660 Application). The '660 Application is hereby incorporated by reference in its entirety as though fully set forth herein.

### BACKGROUND

a. Technical Field

This instant disclosure relates generally to an apparatus for opening and closing a barrier, such as a gate.

b. Background Art

Apparatuses for opening and closing barriers or gates typically include a rod, flat bar, or piston attached to the bottom, middle, or top of the gate, which is not aesthetically pleasing. The terms “gate” and “barrier” are used interchangeably in the instant disclosure and are intended to mean the same thing. Automated gates can be used for walkways or driveways and can be activated via a remote control or pressure switch, among other means. Gates with openers are difficult to install since it is difficult to align the hinge appropriately in the correct position in relation to an opener upon installation. This is especially true for two gates that meet in the center of a driveway and open and close simultaneously. It is difficult to align these two gates so that they are even and positioned along the same line. In other words, the two gates, when in a closed position, should not be offset at an angle from each other. Even after install, the gate(s) may become misaligned over time. A typical gate hinge is nothing more than a fixed pivot point that offers little strength and no adjustability, with both of these attributes being critical to the performance of motorized gate openers.

Thus, it is desirable for these automated gate hinges to be incorporated into the gate itself, with no extraneous parts being unnecessarily visible. Also, it is desirable for these automated gate hinges to not wiggle or oscillate (perhaps due to wind) once in the closed position. In addition, it is desirable for a gate hinge to be easily aligned (or re-aligned) during install and thereafter.

### SUMMARY

The present disclosure describes an apparatus for opening and closing a barrier. In a first embodiment, the apparatus can include a rotatable housing having a first stop surface extending outwardly from an outer surface of the housing, said housing being configured for attachment of said barrier; an electric motor disposed within the housing, said motor having a rotor coupled to a first shaft having an axis, said motor further including a stator; a member configured to receive and mechanically fix an end of a second shaft thereto; and a mounting bracket configured for connection to a fixed post, said mounting bracket connected to the member and having a second adjustable stop surface configured to contact the first stop surface and limit rotational movement of said housing relative to said mounting bracket in a first rotational direction, wherein the motor is configured to be selectively activated to effect relative rotational movement of the rotor relative to the stator, and the rotational movement of the motor relative to the mounting bracket causes rotational movement of the housing relative to the mounting bracket.

The housing may extend along said axis, and said housing, said motor, said member, and said mounting bracket may be disposed at a first longitudinal end of the housing. The housing may further include a motor mounting plate disposed at a first longitudinal end of the housing, wherein the motor mounting plate is connected to the motor and the first stop surface is integral with the motor mounting plate. The housing may further comprise ribs disposed on an inner surface of the housing that extend radially inwardly to support the motor.

In another aspect, the mounting bracket may include a first aperture and a second aperture, and the assembly may further include a flanged bolt and a supporting plate, wherein a first portion of the flanged bolt is disposed in the first aperture of the mounting bracket, a second portion of the flanged bolt is disposed within the supporting plate, and the supporting plate is connected to the member. The second adjustable stop surface may be an end surface of a set screw, a portion of the set screw may be disposed within the second aperture of the mounting bracket, and the end surface of the set screw may contact the first stop surface and limit rotational movement of said housing relative to said mounting bracket in the first rotational direction.

In another aspect, the assembly may further include at least one screw, wherein the member has at least one aperture and the at least one screw extends through the at least one aperture and contacts the second shaft such that the at least one screw maintains the position of the second shaft. A cross section of a portion of the second shaft may be generally rectangular in shape having two flat sides and two rounded sides.

In another aspect, the motor may be configured to minimize movement in a second rotational direction opposite of the first rotational direction.

In a second embodiment, the assembly may further include at least one pivoting means disposed at a second longitudinal end of the housing opposite of said first longitudinal end. In another aspect, an apparatus for opening and closing a barrier may include a rotatable housing having a first stop surface extending outwardly from an outer surface of the housing, said housing being configured for attachment of said barrier; a first hinge assembly; and a second hinge assembly. The first hinge assembly may be disposed at a first longitudinal end of the housing and include an electric motor disposed within the housing, said motor having a rotor coupled to a first shaft having an axis, said motor further including a stator; a first member configured to receive and mechanically fix an end of a second shaft thereto; and a first mounting bracket configured for connection to a fixed post, said first bracket connected to the first member and having a second adjustable stop surface configured to contact the first stop surface and limit rotational movement of said housing relative to said first bracket in a first rotational direction, wherein the motor is configured to be selectively activated to effect relative rotational movement of the rotor relative to the stator, the rotational movement of the motor relative to the bracket causes rotational movement of the housing relative to the bracket, and said first stop surface and said second adjustable stop surface define a first adjustable stop configured to adjust the limit of rotation of the housing relative to said first member and first mounting bracket in the first rotational direction. The second hinge assembly may be disposed at a second longitudinal end of the housing and include a pin; a second member configured to receive and mechanically fix an end of the pin thereto; and a second adjustable stop configured to adjust the limit of rotation of the housing relative to said second member.

In another aspect, the second adjustable stop may comprise a corresponding first stop surface and a corresponding second adjustable stop surface associated therewith. The second hinge assembly may further comprise a second mounting bracket configured for connection to the fixed post, said second mounting bracket connected to the second member and having the second adjustable stop surface of the second hinge assembly, the second adjustable stop surface of the second hinge assembly being configured to contact the first stop surface of the second hinge assembly and limit rotational movement of said housing relative to said second mounting bracket in the first rotational direction.

In another aspect, the housing may include a motor mounting plate disposed on the first longitudinal end of the housing and a pin mounting plate disposed on the second longitudinal end of the housing, the motor mounting plate may be connected to the motor, the first stop surface may be integral with the motor mounting plate, the pin mounting plate may be connected to the pin of the second hinge assembly, and a portion of the second adjustable stop may be integral with the pin mounting plate.

The first mounting bracket may include a first aperture and a second aperture, and the second mounting bracket may include a first aperture and a second aperture. The assembly may further include a first flanged bolt, a second flanged bolt, a first supporting plate, and a second supporting plate, wherein a first portion of the first flanged bolt is disposed in the first aperture of the first bracket, a second portion of the first flanged bolt is disposed within the first supporting plate, the first supporting plate is connected to the first member, a first portion of the second flanged bolt is disposed in the first aperture of the second bracket, a second portion of the second flanged bolt is disposed within the second supporting plate, and the second supporting plate is connected to the second member.

In another aspect, the second adjustable stop surface of the first adjustable stop may be an end of a first set screw, a portion of the first set screw may be disposed within the second aperture of the first mounting bracket, an end of the first set screw may contact the first stop surface of the first adjustable stop and limit rotational movement of said housing relative to said first mounting bracket in the first rotational direction, the second adjustable surface of the second adjustable stop may be an end of a second set screw, a portion of the second set screw may be disposed within the second aperture of the second mounting bracket, and an end of the second set screw may contact the first stop surface of the second adjustable stop and limit rotational movement of said housing relative to said second mounting bracket in the first rotational direction.

The assembly may further comprise at least one screw in the first hinge assembly and at least one screw in the second hinge assembly, wherein the first member has at least one aperture and the at least one screw of the first hinge assembly extends through the aperture of the first member and contacts the portion of the second shaft disposed in the first member such that the at least one screw in the first hinge assembly maintains the position of the second shaft, and the second member has at least one aperture and the at least one screw of the second hinge assembly extends through the at least one aperture of the second member and contacts the portion of the pin disposed in the second member such that the at least one screw in the second hinge assembly maintains the position of the pin.

In another aspect, the second hinge assembly may comprise a jam nut configured to support the pin within the pin mounting plate while permitting the housing to rotate about the axis of the second shaft of the first hinge assembly. A cross section of the second shaft may be generally rectangular in shape having two flat sides and two rounded sides, a cross section of the pin may be generally rectangular in shape having two flat sides and two rounded sides, and the pin may include a flange disposed generally at the longitudinal center of the pin and extending radially outwardly from an outer surface of the pin.

In a third embodiment, an apparatus for opening and closing a barrier may comprise a rotatable housing having a first stop surface extending outwardly from an outer surface of the housing, said housing being configured for attachment of said barrier; an electric motor disposed within the housing, said motor having a rotor coupled to a first shaft having an axis, said motor further including a stator; a member configured to receive and mechanically fix an end of a second shaft; and a mounting bracket configured for connection to a fixed post, said mounting bracket connected to the member and having a second adjustable stop surface configured to contact the first stop surface and limit rotational movement of said housing relative to said mounting bracket in a first rotational direction, wherein the motor is configured to be selectively activated to effect relative rotational movement of the rotor relative to the stator, and the rotational movement of the motor relative to the mounting bracket causes rotational movement of the housing relative to the mounting bracket.

Additional features, advantages, and embodiments may be set forth or become apparent from consideration of the following detailed description, drawings, and claims. Moreover, it is to be understood that both the foregoing summary and the following detailed description are exemplary only and intended to provide explanation without limiting the scope of the invention as claimed.

### BRIEF DESCRIPTION OF THE DRAWINGS

The accompanying drawings, which are included to provide a further understanding are incorporated in and constitute a part of this specification, illustrate preferred embodiments and, together with the detailed description, serve to explain the principles of embodiments of the invention. In the drawings:

FIG. 1 is a perspective view of an apparatus for opening and closing a barrier according to a first embodiment.

FIG. 2 is an exploded perspective view of the apparatus of FIG. 1.

FIG. 3 is a schematic representation of a motor according to an embodiment.

FIGS. 4A-4C are perspective view of portions of the motor.

FIG. 5 is a perspective view of a second hinge assembly according to a second embodiment.

FIG. 6 is an exploded perspective view of the assembly of FIG. 5.

FIG. 7 is a top cross-sectional view taken along line A-A of FIG. 6.

FIG. 8 is a schematic view of a third embodiment.

### DETAILED DESCRIPTION

As described in the Background, automated gate hinges typically involve several extraneous parts and, thus, are not aesthetically pleasing. Also, automated gate hinges tend to wobble or oscillate when in the closed position due to the wind or other environmental conditions. In addition, gate hinges can be difficult to align during installation and thereafter (during the service life of the system). Therefore, there is a need for an apparatus for opening and closing a barrier that is aesthetically pleasing, allows the barrier to remain stationary when in the closed position (not wiggle or oscillate), and provides a mechanism to allow adjustment so as to permit an operator to align the barrier to a desired position during installation and/or thereafter (during the service life of the system).

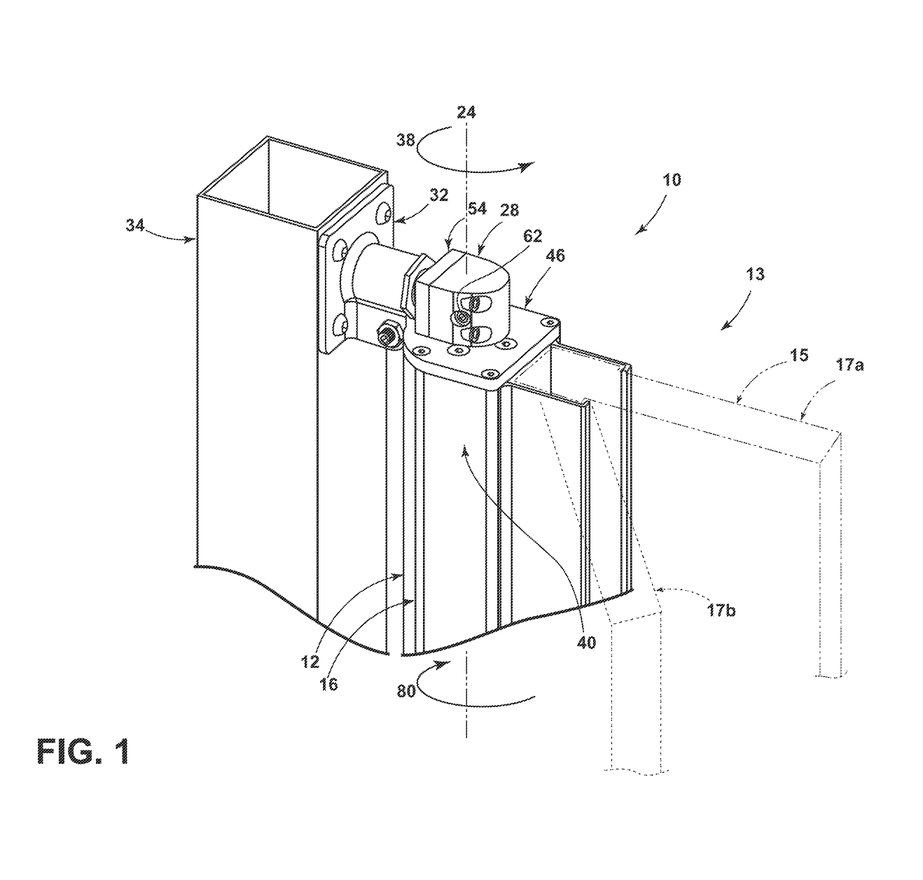

Referring now to the drawings wherein like reference numerals are used to identify identical or similar components in the various views, FIG. 1 is a perspective view of an apparatus 13 for opening and closing a barrier 15 (shown in phantom lines) according to a first embodiment. Apparatus 13 includes a first hinge assembly 10. First hinge assembly 10 is configured for attachment to barrier 15 (shown in phantom lines) and to a fixed post 34. First hinge assembly 10 allows for rotation about axis 24 in rotational directions 38, 80. Such rotation effectuates the opening and closing of barrier 13. In position 17a, barrier 15 is in a closed position. In position 17b, barrier 15 is approximately halfway between the closed and open positions. Apparatus 13 in accordance with a first embodiment can be made from aluminum, steel, brass and stainless steel, for example and without limitation. Although these materials are mentioned in detail, the apparatus can be comprised of any number of other materials in accordance with various embodiments.

Still referring to FIG. 1, in a first embodiment, apparatus 13 includes first hinge assembly 10 and a rotatable housing 12. First hinge assembly 10 is disposed at a first longitudinal end 40 of housing 12 and includes a first member 28 and a first mounting bracket 32. Housing 12 is configured for rotation about axis 24 in a first directional rotation 38 and a second rotational direction 80 relative to first mounting bracket 72. First member 28 is adjacent to housing 12 along axis 24 and is configured for connection with first mounting bracket 32. First mounting bracket 32 is configured for attachment to fixed post 34. During operation, first member 28 and first mounting bracket 32 remain stationary while housing 12 rotates about axis 24.

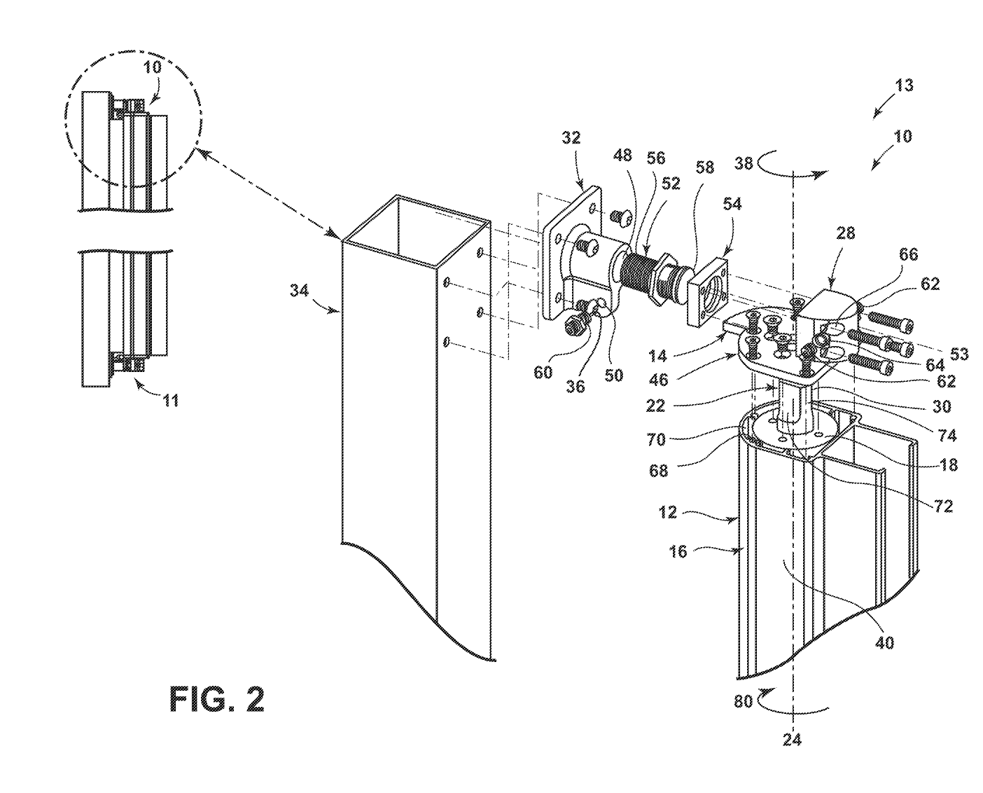

FIG. 2 is an exploded perspective view of the apparatus of FIG. 1 showing more detail. Apparatus 13 may include first hinge assembly 10 by itself or first hinge assembly 10 along with second hinge assembly 11. FIG. 2 shows first hinge assembly 10 at the top of barrier 15 and second hinge assembly 11 at the bottom; however, this orientation can be switched. Moreover, FIG. 2 shows the assemblies 10, 11 attached to a fixed post 34 on the left side of the walkway or driveway; however, the assemblies 10, 11 can be attached to a fixed post 34 on the right side as well.

Still referring to FIG. 2, first hinge assembly 10 further includes an electric motor 18, a first motor mounting plate 46, a first supporting plate 54 attached to first member 28, and a first flanged bolt 52 disposed within first mounting bracket 32. Motor 18 is configured to effect rotational movement of motor 18 itself relative to first mounting bracket 32, causing rotational movement of housing 12 relative to first mounting bracket 32. First hinge assembly 10 has a shaft 22 with axis 24. Shaft 22 extends from inside motor 18 and into an aperture (not shown) in first member 28. A portion 30 of shaft 22 that extends into first member 28 is generally rectangular-shaped and includes two flat sides 72 and two rounded sides 74. At least one screw 62 extends through an aperture 64 of first member 28 and contacts a flat side 72 of shaft 22 to maintain the position of shaft 22 within first member 28. Another screw 62 can be used in the same manner on the opposite side (180 degrees) of first member 28. Because shaft 22 is rounded upon entering motor 18, rotational movement is permitted about shaft 22. However, because a portion 30 of shaft 22 is held stationary in first member 28, shaft 22 does not rotate but, instead, motor 18 itself rotates about axis 24 relative to first mounting bracket 32.

Still referring to FIG. 2, motor 18 is connected to motor mounting plate 46 via screws or welding. Motor mounting plate 46 is also connected to housing 12 via screws or welding. Due to these connections, the rotational movement of motor 18 causes housing 12 to rotate therewith, thus effectuating the opening and closing of barrier 15 (show in phantom lines in FIG. 1). As discussed above, first member 28 remains fixed along with first mounting bracket 32 and shaft 22, while motor mounting plate 46, motor 18, and housing 12 all rotate in rotational directions 38, 80.

In a first embodiment, first flanged bolt 52 and first supporting plate 54 allow first member 28 to connect to first mounting bracket 32. First member 28 attaches to first supporting plate 54 via screws or welding. First mounting bracket 32 includes a first aperture 48 and a second aperture 50, both of which may be threaded. First flanged bolt 52 includes a first portion 56 and a second portion 58. Second portion 58 of first flanged bolt 52 includes a flange and is disposed within a channel of first supporting plate 54. First portion 56 of first flanged bolt 52 is threaded and extends into first aperture 48 of first mounting bracket 32 on the other side. First mounting bracket 32 can be connected to fixed post 34 via screws or welding.

Still referring to FIG. 2, in the first embodiment, first hinge assembly 10 further comprises a first adjustable stop which is configured to limit rotational movement of housing 12 relative to first mounting bracket 32 in a first rotational direction 38. First adjustable stop includes a first stop surface 14 and a second adjustable stop surface 36. First stop surface 14 is disposed on motor mounting plate 46. Alternatively, first stop surface can be disposed on an outer surface 16 of housing 12. First stop surface 14 extends in a direction parallel to an axis 53 of first flanged bolt 52 when first hinge assembly 10 is in the closed position. Second adjustable stop surface 36 may be an end of a set screw. A portion 60 of set screw extends through second aperture 50 on one side of first mounting bracket 32, and second adjustable stop 36 surface (i.e., end of set screw) extends outside of first mounting bracket 32 on the other side of first mounting bracket 32. By having second adjustable stop surface 36 be a set screw, the closed position can easily be set during install or thereafter. With this stop mechanism, a fixed post in the ground separate from the gate is unnecessary. Moreover, screws are very inexpensive, so the replacement cost is negligible.

FIG. 2 shows apparatus 13 in the closed position. Upon moving from an open position to a closed position, motor 18 rotates housing 12 and first stop surface 14 in first rotational direction 38. Motor 18 turns off (and thus barrier 15 stops moving) once first stop surface 14 contacts second adjustable stop surface 36 (or at some point thereafter). At this point, barrier 15 (shown in phantom lines in FIG. 1) is in the closed position. While in the closed position, the torque generated by first stop surface 14 pushing against second adjustable stop surface 36 is held constant. In other words, housing 12 (and thus barrier 15) is not permitted to rotate further in first rotational direction 38. Therefore, barrier 15 does not wiggle or oscillate in first rotational direction 38 when in the closed position due to this constant torque. Furthermore, barrier does not wiggle or oscillate in second rotational direction 80 due to a constant internal torque in second rotational direction 80 within motor 18.

In the first embodiment, rotatable housing 12 (once installed) extends from one vertical end of the top of the barrier (shown in phantom lines in FIG. 1) to the other vertical end and includes two channels. The first channel is where motor 18 resides, and the second channel is where a portion of barrier 15 resides. The first channel can be generally square-shaped with one rounded side disposed adjacent to first mounting bracket 32 when the barrier is in the closed position. The second channel can be generally U-shaped, with the “U” opening away from first mounting bracket 32 (when in a closed position). Motor 18 is disposed at first longitudinal end 40 of housing 12 and is positioned therein via ribs 68 in housing 12. Ribs 68 extend radially inwardly from an inner surface 70 of housing 12 and are configured to center/support motor 18 within housing 12.

In an embodiment, motor 18 can be selectively activated via a control unit (not shown). An operator can selectively activate the motor by activating a switch, such as by use of a remote control or pressure switch (i.e., as the operator nears the gate, a pressure switch disposed in the ground activates the motor). Once activated, a signal is sent via a wire or wirelessly to the control unit (not shown) of motor 18. The control unit then commands motor 18 to rotate in either the first rotational direction 38 or second rotational direction 80. The control unit and motor 18 can be powered via a 110-volt source, and a transformer disposed within the control unit can convert the 110 volts into 24 volts. A battery can also be incorporated into the control unit so that apparatus 13 can still be operable even if there is a loss of power. Alternatively, in a further embodiment, the control unit and motor 18 can be powered via a solar panel. In such an embodiment, a battery in the control unit stores the energy generated via the solar panel and powers the control unit and motor 18. Motor 18 is typically connected to the control unit with wires (not shown in the figures).

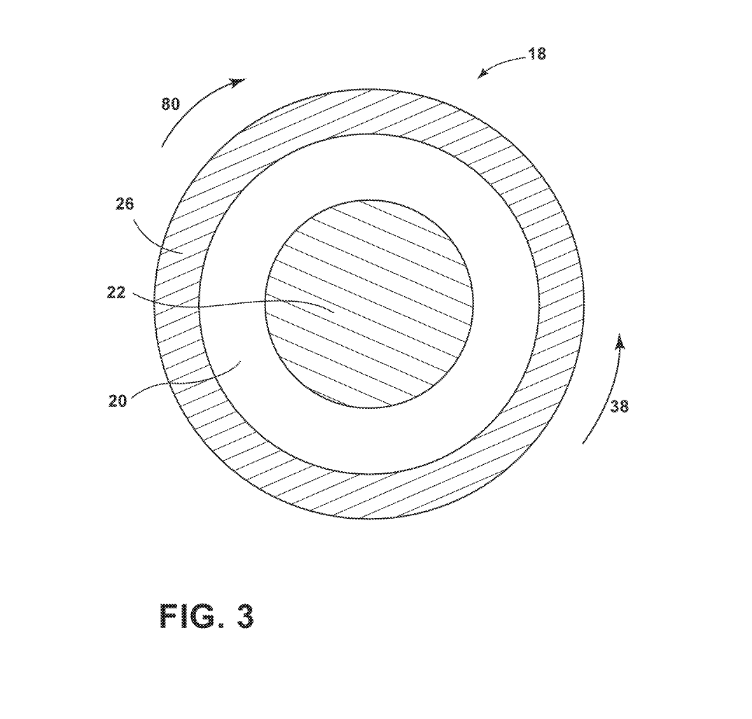

FIG. 3 is a schematic representation of a motor according to the first embodiment. Motor 18 may comprise a rotor 20, a stator 26, and a motor shaft 23 displaced along axis 24 of shaft 22. Although motor shaft 23 is aligned with shaft 22 along axis 24, motor shaft 23 may be offset from axis 24. Motor 18 is selectively activated to effect relative rotational movement 38, 80 of rotor 20 relative to stator 26. Rotor 20 is coupled to shaft 23 (shown in FIG. 2); thus, shaft 23 rotates with rotor 20. The rotational movement in rotational directions 38, 80 of shaft 23 causes rotational movement 38, 80 of housing 12 relative to first mounting bracket 32.

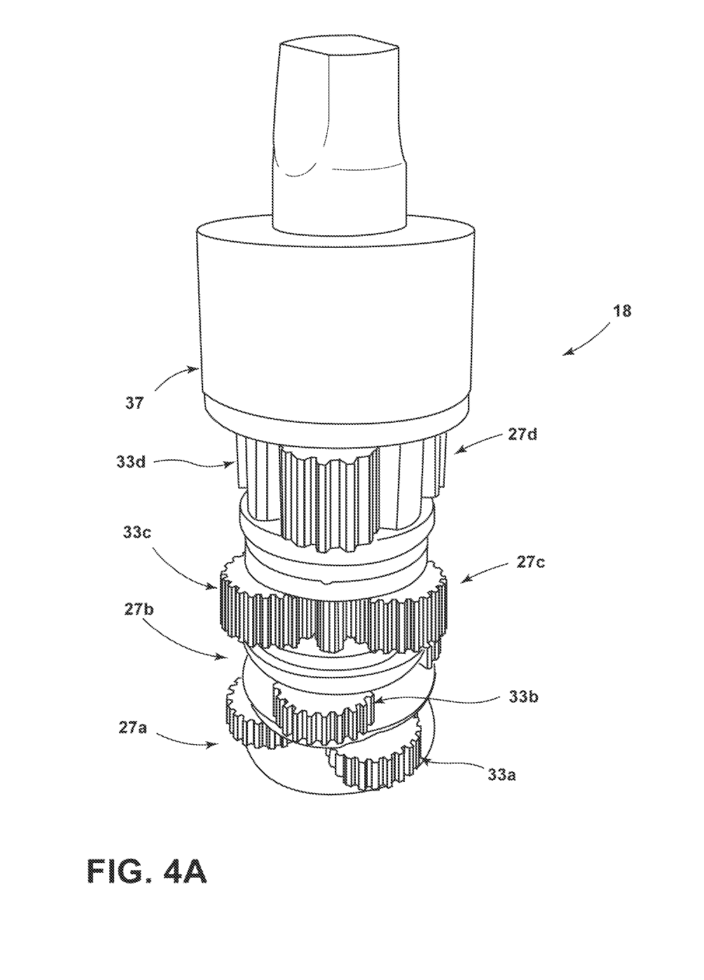

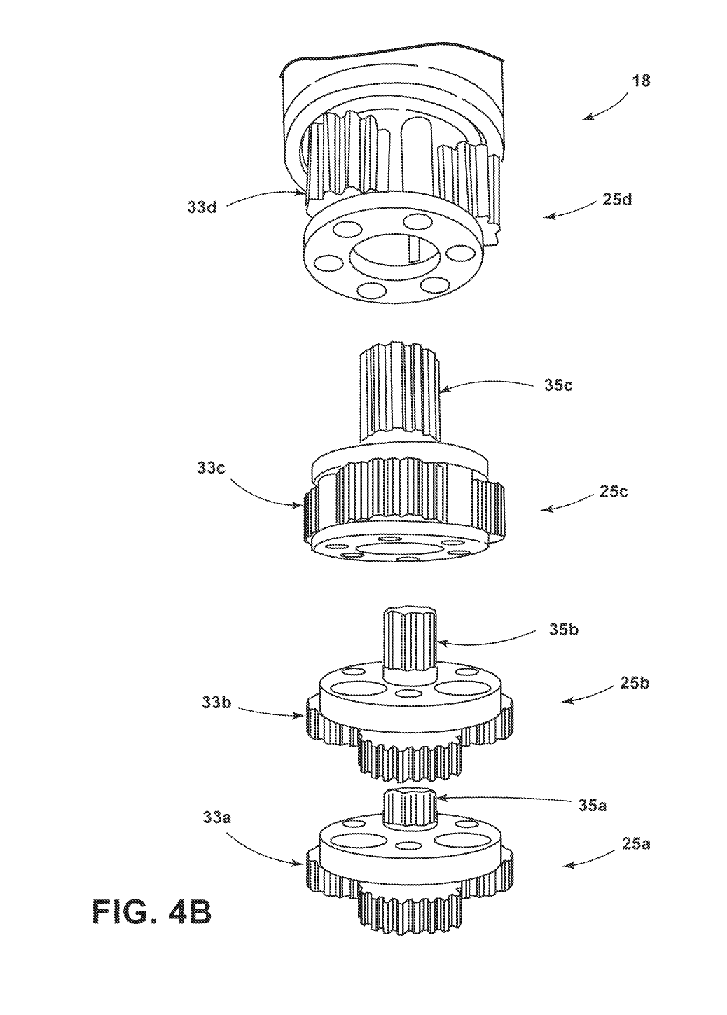

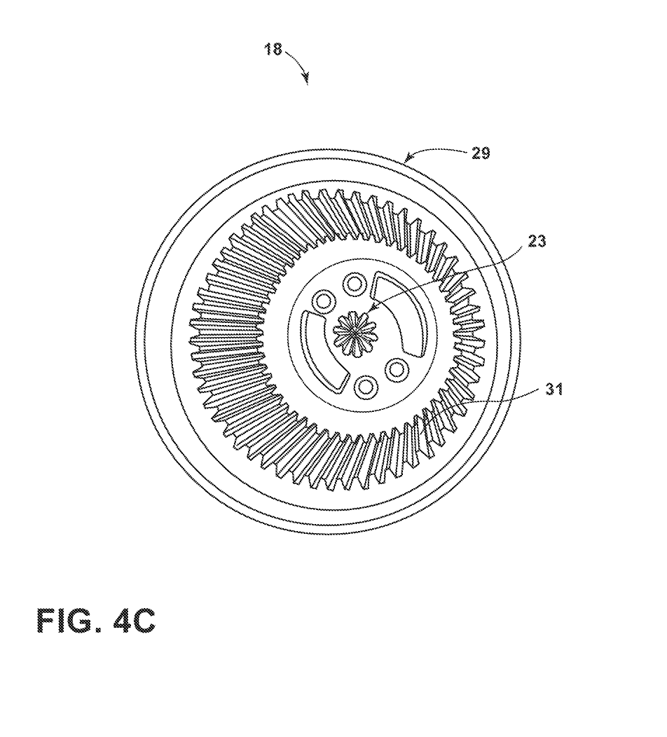

FIGS. 4a-4c are schematic views of portions of motor 18. Motor 18 includes gear assemblies 25a-d (as shown in FIGS. 4a-4b) and cup 29 (as shown in FIG. 4c). Shaft 23, which is splined (as shown in FIG. 4c), drives the rotation of gear assembly 25a, which in turn drives the rotation of gear assembly 25b, which in turn drives the rotation of gear assembly 25c, which in turn drives the rotation of gear assembly 25d. Gear assemblies 25a-d fit within cup 29 and mesh with cup gear 31. Cup gear 31 remains stationary and acts as a guide for each gear assembly 25a-d. Gear assemblies 25a-d serve to generate torque within motor 18. While shaft 22 held stationary by first member 28 (as shown in FIGS. 1-2), motor shaft 23 rotates and causes rotation of housing 12.

As shown in FIG. 4b, gear assemblies 25a-d each include a set of gears 33a-d and a splined shaft 35a-d (splined shaft 35d not shown). Motor shaft 23 (shown in FIG. 4c) extends into gear assembly 25a; splined shaft 35a extends into gear assembly 25b; splined shaft 35b extends into gear assembly 25c; and splined shaft 35c extends into gear assembly 25d; and splined shaft 35d (not shown) drives rotation of motor body 37. Thus, motor shaft 23 drives the rotation of motor body 37 via gear assemblies 25a-d, and the rotation of motor body 37 drives rotation of housing 12.

There may be four rows 27a-d arranged longitudinally along shaft 23. Also, there may be three gears in each set of gears 33a-d in each row 27a-d. Within each row 27a-d, the individual gears may be spaced evenly from each other. However, the individual axes for each respective gear may be located at different positions about their respective splined shaft 35a-d from row to row 27a-d.

Motor 18 can be a drum motor, and such fixed-shaft-type motors are used (for example) to drive conveyer belts. Such a motor can be the Hide SW 24-volt motor, commercially available from BFT Spa in Schio, Italy. The Hide SW motor is able to be completely integrated within housing 12. Disappearing completely within housing 12, the Hide SW motor allows the apparatus 13 and barrier 15 to have a “clean” look while still being a fundamental element of operational performance. The Hide SW motor functions can be optimized through separate management, torque control, speed, and other means of calibration.

Limit switches can be set into the memory of motor 18 via the control unit. To set the limit switch, barrier 15 is moved to the open position, and the position of motor 18 is then recorded into the memory of the control unit. With respect to the closed position, motor 18 is turned on, and once first stop surface 14 contacts second adjustable stop surface 36, the operator counts to (for example) three seconds, and then sets the limit switch. This will ensure that there is a constant torque between first stop surface 14 and second adjustable stop surface 36 while the barrier is in the closed position.

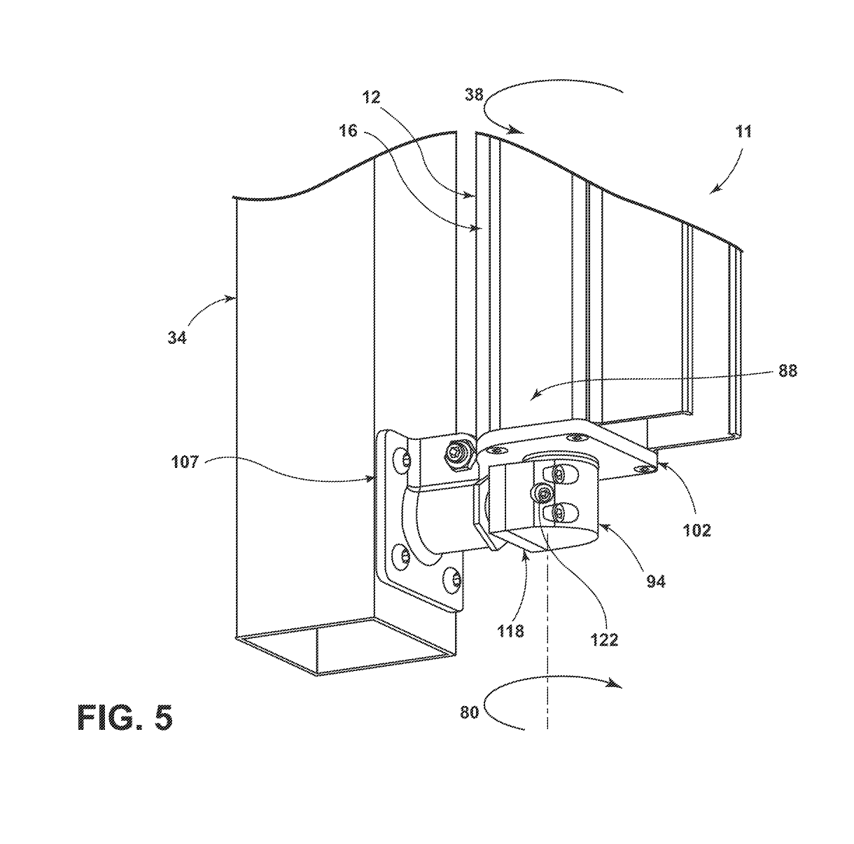

FIG. 5 is a perspective view of a second hinge assembly 11 according to a second embodiment. In the second embodiment, apparatus 13 includes first hinge assembly 10 (shown in FIGS. 1-2) and second hinge assembly 11. Second hinge assembly 11 can function as a pivoting means and is disposed at a second longitudinal end 88 of housing 12.

Second hinge assembly 11 is disposed at a second longitudinal end 88 of housing 12 and includes a second member 94 and a second mounting bracket 107. Second hinge assembly 11 is configured for attachment to barrier 15 (shown in phantom lines in FIG. 1) and to fixed post 34. Housing 12 is configured for rotation about axis 24 in a first directional rotation 38 and a second rotational direction 80 relative to second mounting bracket 107. Second member 94 is adjacent to housing 12 along axis 24 and is configured for connection with second mounting bracket 107. Second mounting bracket 107 is configured for attachment to fixed post 34. During operation, second member 94 and second mounting bracket 107 remain stationary while housing 12 rotates about axis 24.

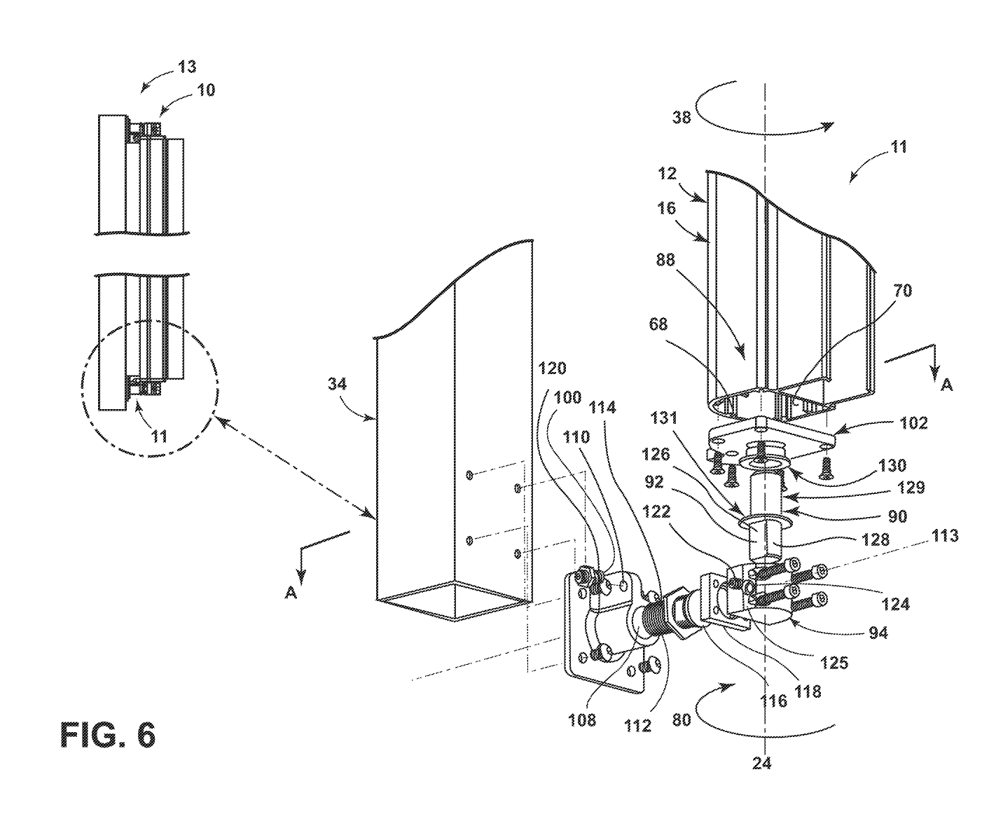

FIG. 6 is an exploded perspective view of the assembly of FIG. 5 showing more detail. Similar to first hinge assembly 10, second hinge assembly 11 further includes a pin 90, a jam nut 130, a pin mounting plate 102, a second supporting plate 118, and a second flanged bolt 112. Pin 90 having a flange 131 is positioned along axis 24 of shaft 22. Pin 90 extends outside of housing 12 and into an aperture (not shown) in second member 94. A portion 92 of pin 90 that is received by second member 94 is generally rectangular-shaped and includes two flat sides 126 and two rounded sides 128. At least one screw 122 extends through an aperture 124 of second member 94 and contacts a flat side 126 of pin 90 to maintain the position of pin 90 within second member 94. Another screw 122 (not shown) can be used in the same manner on the opposite side (180 degrees) of second member 94. Because a portion 129 of pin 90 is rounded upon entering housing 12, rotational movement of housing 12 is permitted about pin 90. However, because a portion 92 of pin 90 is held stationary in second member 94, pin 90 does not rotate but, instead, housing 12 is permitted to rotate about axis 24 relative to second mounting bracket 107. Specifically, jam nut 130 disposed between flange 131 and pin mounting plate 102 rotates along flange 131. Furthermore, because pin mounting plate 102 is connected to housing 12, pin mounting plate 102 rotates with housing 12. Second member 94 remains fixed along with second mounting bracket 107.

Still referring to FIG. 6, pin mounting plate 102 is connected to housing 12 via screws or welding and thus rotates with housing 12. Second member 28 remains fixed along with second mounting bracket 107 and pin 90, while pin mounting plate 102 and housing 12 rotate in rotational directions 38, 80.

In a second embodiment, second flanged bolt 112 and second supporting plate 118 allow second member 94 to connect to second mounting bracket 107. Second member 94 attaches to second supporting plate 118 via screws or welding. Second mounting bracket 107 includes a first aperture 108 and a second aperture 110, both of which are threaded. Second flanged bolt 112 includes a first portion 114 and a second portion 116. Second portion 116 of second flanged bolt 112 includes a flange and is disposed within a channel of second supporting plate 118. First portion 114 of second flanged bolt 112 is threaded and extends into first aperture 108 of second mounting bracket 107 on the other side. Second mounting bracket 107 can be connected to fixed post 34 via screws or welding.

Still referring to FIG. 6, in the second embodiment, second hinge assembly 11 further comprises a second adjustable stop which is configured to limit rotational movement of housing 12 relative to second mounting bracket 107 in a first rotational direction 38. Second adjustable stop includes a first stop surface 98 and a second adjustable stop surface 100. First stop surface 98 is disposed on pin mounting plate 102. Alternatively, first stop surface 98 can be disposed on an outer surface 16 of housing 12. First stop surface 98 extends in a direction parallel to an axis 113 of second flanged bolt 112 when second hinge assembly 11 is in the closed position. Second adjustable stop surface 100 may be an end of a set screw. A portion 120 of set screw extends through second aperture 110 on one side of second mounting bracket 107, and second adjustable stop 100 surface (i.e., end of set screw) extends outside of second mounting bracket 107 on the other side of second mounting bracket 107. By having second adjustable stop surface 100 be a set screw, the closed position can easily be set during install or thereafter.

During operation, rotation of housing 12 is driven by motor 18 of first hinge assembly 10, and second hinge assembly 11 acts as an additional guide and/or pivoting means. Because pin mounting plate 102 of second hinge assembly 11 and motor mounting plate 46 of first hinge assembly 10 are mirror images of each other, they can be easily switched, thus allowing the barrier 15 to open and close in the opposite directions. For example, in the embodiment of FIG. 6 the barrier 15 opens in second rotational direction 80. If pin mounting plate 102 were used as motor mounting plate 46 (and thus moved to first longitudinal end 40 of housing 12), the barrier 15 would open in first rotational direction 38. This versatility is advantageous.

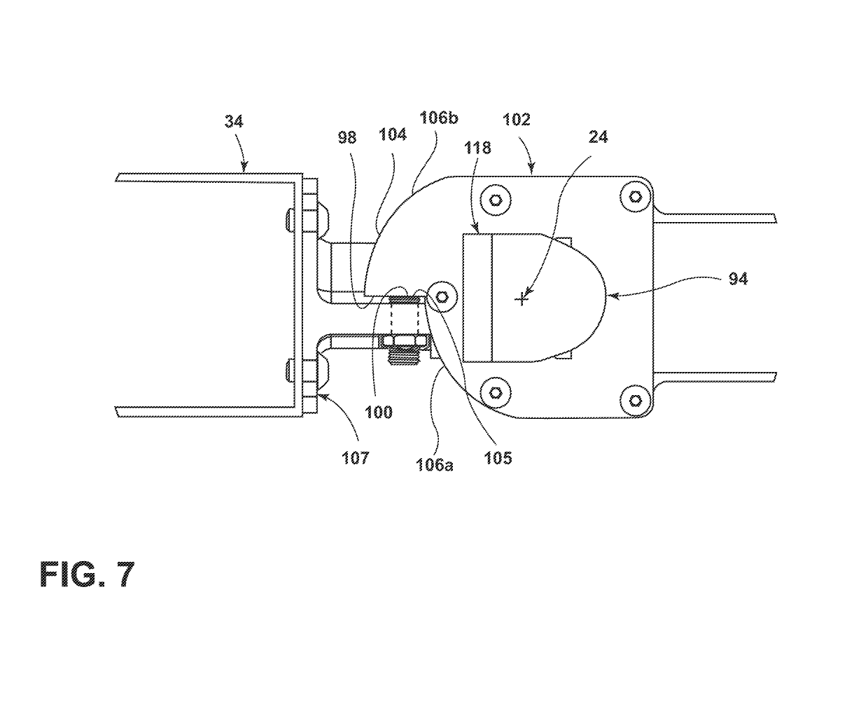

FIG. 7 is a cross-sectional view taken along line A-A of FIG. 6. In an embodiment, pin mounting plate 102 (and motor mounting plate 46) can be square-shaped with rounded corners, except on the side 104 facing second mounting bracket 107 (when in the closed position), there are two rounded surfaces 106a, b and a flat surface 105. Flat surface 105 corresponds to second adjustable stop surface 100. The radius of curvature of rounded surface 106a is smaller than the radius of curvature of rounded surface 106b (with respect to axis 24 of shaft 22), the difference being approximately the length of flat surface 105. Motor mounting plate 46 is a mirror image of pin mounting plate 102 (when viewed from the top upon installation).

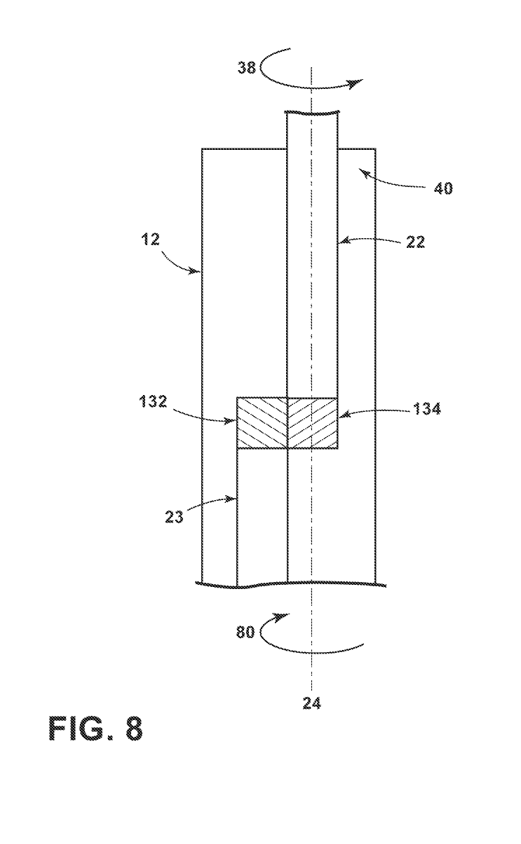

FIG. 8 is a schematic view of a third embodiment. In this embodiment, shaft 23 is the shaft of motor 18. Gear 132 is at one end of motor shaft 23 and meshes with gear 134 disposed at an end of shaft 22, which extends into first member 28 at first longitudinal end 40 of housing 12. With this arrangement, the axis about which housing 12 rotates can be offset from the center axis of housing 12, and axis of motor shaft 23 may be offset from axis 24 of shaft 22. One of ordinary skill in the art will recognize that motor 18 can include various arrangements of shafts and gears to effectuate rotational movement of housing 12 about fixed shaft 22.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. Numerous specific details are set forth and/or illustrated to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Although at least one embodiment of this disclosure has been described and illustrated with a certain degree of particularity, those skilled in the art could make numerous alterations to the disclosed embodiment without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the disclosure. Joinder references (e.g., attached, coupled, connected, and the like) are to be construed broadly and can include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure can be made without departing from the spirit of the disclosure as defined in the appended claims.

What is claimed is:

1. An apparatus for opening and closing a barrier comprising:
a rotatable housing having a first stop surface extending outwardly from an outer surface of the housing, said housing being configured for attachment of said barrier;
an electric motor disposed within the housing, said motor having a rotor coupled to a first shaft having an axis, said motor further including a stator;
a member configured to receive and mechanically fix an end of a second shaft; and
a mounting bracket configured for connection to a fixed post, said mounting bracket connected to the member and having a second adjustable stop surface configured to contact the first stop surface and limit rotational movement of said housing relative to said mounting bracket in a first rotational direction,
wherein the motor is configured to be selectively activated to effect relative rotational movement of the rotor relative to the stator, and the rotational movement of the motor relative to the mounting bracket causes rotational movement of the housing relative to the mounting bracket.

2. The apparatus of claim 1, wherein the housing extends along said axis, and said housing, said motor, said member, and said mounting bracket are disposed at a first longitudinal end of the housing, the assembly further including at least one pivoting means disposed at a second longitudinal end of the housing opposite of said first longitudinal end.

3. The apparatus of claim 1, wherein the housing includes a motor mounting plate disposed at a first longitudinal end of the housing, wherein the motor mounting plate is connected to the motor and the first stop surface is integral with the motor mounting plate.

4. The apparatus of claim 1, wherein the mounting bracket includes a first aperture and a second aperture.

5. The apparatus of claim 4, comprising a flanged bolt and a supporting plate, wherein a first portion of the flanged bolt is disposed in the first aperture of the mounting bracket, a second portion of the flanged bolt is disposed within the supporting plate, and the supporting plate is connected to the member.

6. The apparatus of claim 4, wherein the second adjustable stop surface is an end surface of a set screw, a portion of the set screw is disposed within the second aperture of the mounting bracket, and the end surface of the set screw contacts the first stop surface and limits rotational movement of said housing relative to said mounting bracket in the first rotational direction.

7. The apparatus of claim 1, comprising at least one screw, wherein the member has at least one aperture and the at least one screw extends through the at least one aperture and contacts the second shaft such that the at least one screw maintains the position of the second shaft.

8. The apparatus of claim 1, wherein the housing comprises ribs disposed on an inner surface of the housing that extend radially inwardly to support the motor.

9. The apparatus of claim 1, wherein a cross section of a portion of the second shaft is generally rectangular in shape having two flat sides and two rounded sides.

10. The apparatus of claim 1, wherein the motor is configured to minimize movement in a second rotational direction opposite of the first rotational direction.

11. An apparatus for opening and closing a barrier comprising:
a rotatable housing having a first stop surface extending outwardly from an outer surface of the housing, said housing being configured for attachment of said barrier;
a first hinge assembly disposed at a first longitudinal end of the housing comprising:
an electric motor disposed within the housing, said motor having a rotor coupled to a first shaft having an axis, said motor further including a stator;
a first member configured to receive and mechanically fix an end of a second shaft thereto; and
a first mounting bracket configured for connection to a fixed post, said first bracket connected to the first member and having a second adjustable stop surface configured to contact the first stop surface and limit rotational movement of said housing relative to said first bracket in a first rotational direction,
wherein the motor is configured to be selectively activated to effect relative rotational movement of the rotor relative to the stator, the rotational movement of the motor relative to the bracket causes rotational movement of the housing relative to the bracket, and said first stop surface and said second adjustable stop surface define a first adjustable stop configured to adjust the limit of rotation of the housing relative to said member and first bracket in the first rotational direction; and
a second hinge assembly disposed at a second longitudinal end of the housing comprising:
a pin;
a second member configured to receive and mechanically fix an end of the pin thereto; and
a second adjustable stop configured to adjust the limit of rotation of the housing relative to said second member.

12. The apparatus of claim 11, wherein the second adjustable stop comprises a corresponding first stop surface and a corresponding second adjustable stop surface associated therewith.

13. The apparatus of claim 12, wherein the second hinge assembly comprises a second mounting bracket configured for connection to the fixed post, said second mounting bracket connected to the second member and having the second adjustable stop surface of the second hinge assembly, the second adjustable stop surface of the second hinge assembly being configured to contact the first stop surface of the second hinge assembly and limit rotational movement of said housing relative to said second mounting bracket in the first rotational direction.

14. The apparatus of claim 11, wherein the housing includes a motor mounting plate disposed on the first longitudinal end of the housing and a pin mounting plate disposed on the second longitudinal end of the housing, the motor mounting plate is connected to the motor, the first stop surface is integral with the motor mounting plate, the pin mounting plate is connected to the pin of the second hinge assembly, and a portion of the second adjustable stop is integral with the pin mounting plate.

15. The apparatus of claim 13, wherein the first mounting bracket includes a first aperture and a second aperture, and the second mounting bracket includes a first aperture and a second aperture.

16. The apparatus of claim 15, comprising a first flanged bolt, a second flanged bolt, a first supporting plate, and a second supporting plate, wherein a first portion of the first flanged bolt is disposed in the first aperture of the first bracket, a second portion of the first flanged bolt is disposed within the first supporting plate, the first supporting plate is connected to the first member, a first portion of the second flanged bolt is disposed in the first aperture of the second bracket, a second portion of the second flanged bolt is disposed within the second supporting plate, and the second supporting plate is connected to the second member.

17. The apparatus of claim 13, wherein the second adjustable stop surface of the first adjustable stop is an end of a first set screw, a portion of the first set screw is disposed within the second aperture of the first mounting bracket, an end of the first set screw contacts the first stop surface of the first adjustable stop and limits rotational movement of said housing relative to said first mounting bracket in the first rotational direction, the second adjustable surface of the second adjustable stop is an end of a second set screw, a portion of the second set screw is disposed within the second aperture of the second mounting bracket, and an end of the second set screw contacts the first stop surface of the second adjustable stop and limits rotational movement of said housing relative to said second mounting bracket in the first rotational direction.

18. The apparatus of claim 11, comprising at least one screw in the first hinge assembly and at least one screw in the second hinge assembly, wherein the first member has at least one aperture and the at least one screw of the first hinge assembly extends through the aperture of the first member and contacts the portion of the second shaft disposed in the first member such that the at least one screw in the first hinge assembly maintains the position of the second shaft, and the second member has at least one aperture and the at least one screw of the second hinge assembly extends through the at least one aperture of the second member and contacts the portion of the pin disposed in the second member such that the at least one screw in the second hinge assembly maintains the position of the pin.

19. The apparatus of claim 11, wherein the second hinge assembly comprises a jam nut configured to support the pin within the pin mounting plate while permitting the housing to rotate about the axis of the first shaft of the motor of the first hinge assembly.

20. The apparatus of claim 11, wherein a cross section of the second shaft is generally rectangular in shape having two flat sides and two rounded sides, a cross section of the pin is generally rectangular in shape having two flat sides and two rounded sides, and the pin includes a flange disposed generally at the longitudinal center of the pin and extending radially outwardly from an outer surface of the pin.

21. The apparatus of claim 1, wherein the axis of the shaft of the motor is a first axis, the second shaft has a second axis, and the first axis and second axis are offset from each other.
